(19) United States
(12) Patent Application Publication
(10) Pub. No.: US 2015/0063315 A1
(43) Pub. Date: Mar. 5, 2015

(54) SUB-CHANNEL SELECTION TO REDUCE LATENCY OF CIRCUIT-SWITCHED FALLBACK

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/015,774

(22) Filed: Aug. 30, 2013

(51) Int. Cl. H04W 74/08; H04J 3/16

(52) U.S. Cl. CPC H04W 74/0833; H04J 3/1694; H04J 2013/165
USPC 370/335

(57) ABSTRACT

It is determined whether a specific call type occurs. A random access preamble is transmitted at an earliest available sub-channel when the specific call type occurs. The random access preamble is transmitted at an assigned sub-channel when the specific call type does not occur. The call type can be a circuit switched fall back (CSFB) call or an emergency call.

### TECHNICAL FIELD

Aspects of the present disclosure relate generally to wireless communication systems, and more particularly, to sub-channel selection to reduce the latency of circuit-switched fallback (CSFB) to a radio access technology (RAT), such as Time Division-Code Division Multiple Access (TD-CDMA).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes determining whether a specific call type occurs. The method also includes transmitting a random access preamble at an earliest available sub-channel when the specific call type occurs. The method further includes transmitting the random access preamble at an assigned sub-channel when the specific call type does not occur.

Another aspect discloses an apparatus for wireless communication including means for determining whether a specific call type occurs. The apparatus also includes means for transmitting a random access preamble at an earliest available sub-channel when the specific call type occurs. The apparatus further includes means for transmitting the random access preamble at an assigned sub-channel when the specific call type does not occur.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining whether a specific call type occurs. The program code also causes the processor(s) to transmit a random access preamble at an earliest available sub-channel when the specific call type occurs. The program code further causes the processor(s) to transmit the random access preamble at an assigned sub-channel when the specific call type does not occur.

Another aspect discloses a wireless communication apparatus having a memory and at least one processor coupled to the memory. The processor(s) is configured to determine whether a specific call type occurs. The processor(s) is also configured to transmit a random access preamble at an earliest available sub-channel when the specific call type occurs. The processor(s) is further configured to transmit the random access preamble at an assigned sub-channel when the specific call type does not occur.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a call flow of a typical network.

FIG. 6 illustrates a call flow of another typical network.

FIG. 7A illustrates a timing diagram of typical subframes for use by an uplink pilot channel.

FIG. 7B illustrates a diagram of subframes according to aspects of the present disclosure.

FIG. 8 is a block diagram illustrating a wireless communication method for transmission of preambles according to aspects of the present disclosure.

FIG. 9 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

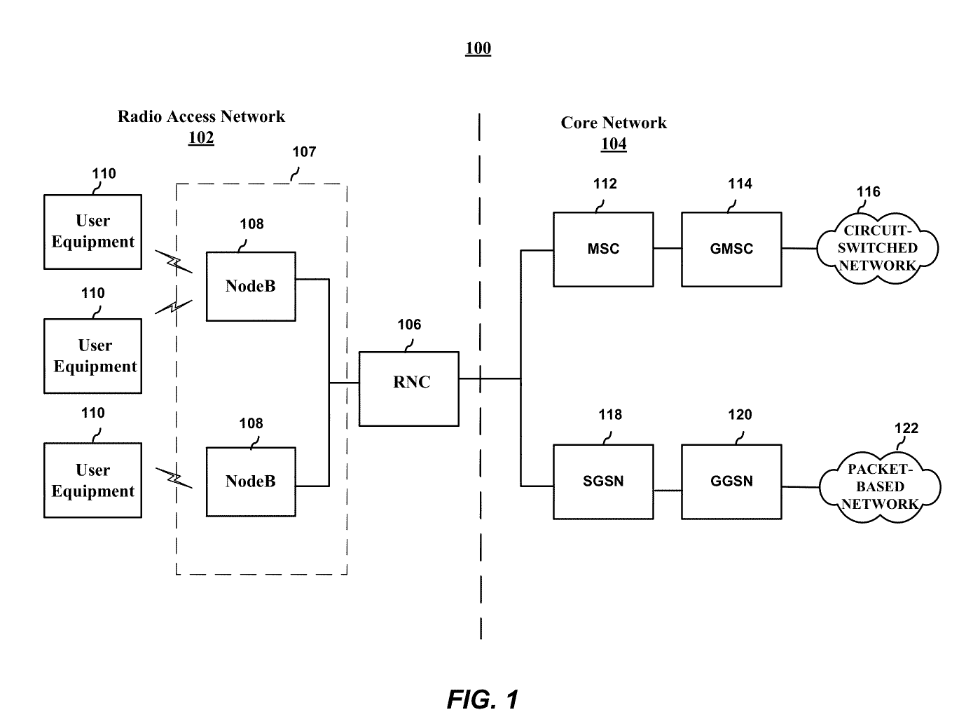

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

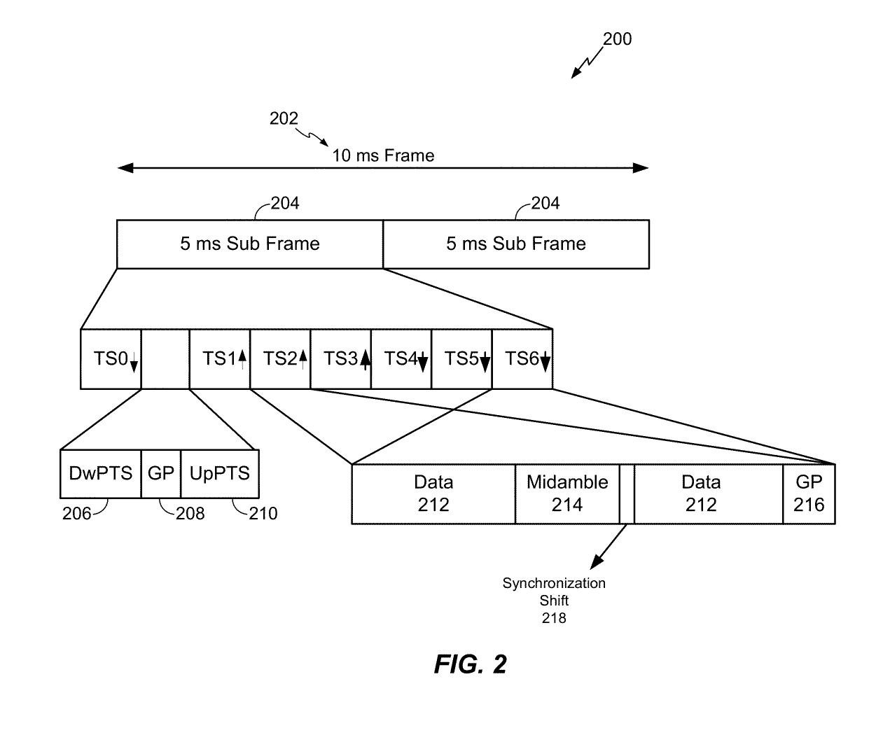

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

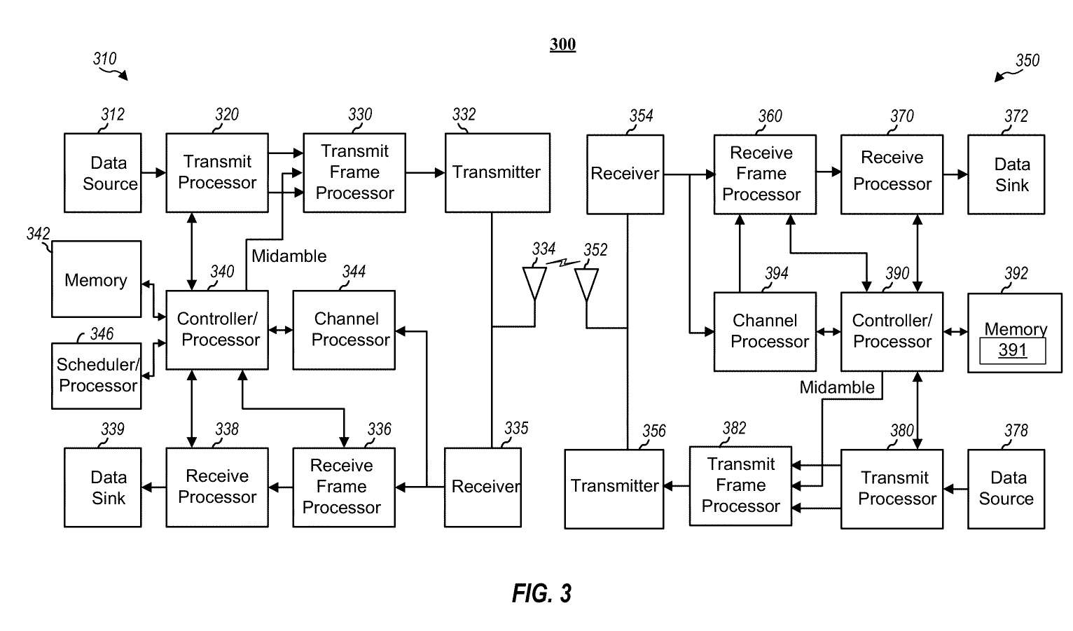

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a preamble transmission module 391 which, when executed by the controller/processor 390, configures the UE 350 to transmit preambles based on aspects of the present disclosure. A scheduler/processor 346 at the node B 310 may be used to allocate resources to the UEs and schedule downlink and/or uplink transmissions for the UEs.

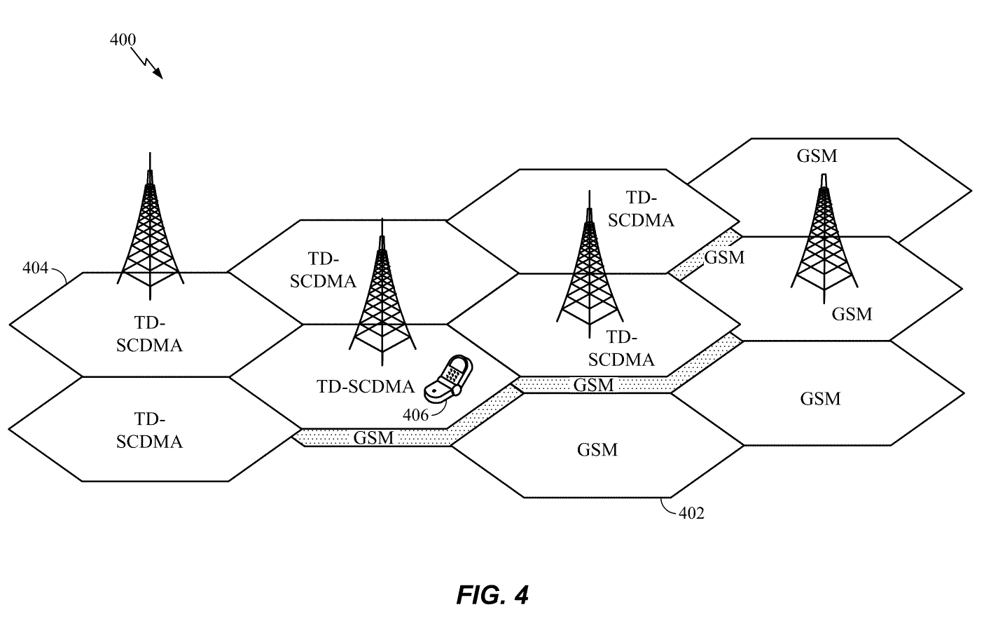

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Sub-Channel Selection to Reduce Latency of Circuit-Switched Fallback

Aspects of the disclosure are directed to sub-channel selection for reducing latency of circuit-switched fall back (CSFB) from one radio access technology (RAT) to another RAT, such as Time Division-Code Division Multiple Access (TD-CDMA).

Redirection from one RAT to another RAT is commonly used, for example, to perform operations such as load balancing or circuit switched fall back from one RAT, such as Long Term Evolution (LTE), to another RAT, such as Universal Mobile Telecommunications System-Frequency Division Duplexing (UMTS FDD), Universal Mobile Telecommunications System-Time Division Duplexing (UMTS TDD), or Global System for Mobile Communications (GSM).

Circuit-switched fall back is a feature that enables multimode user equipment (UE) to provide available circuit-switched (CS) voice services. Multimode UEs refer to UEs that are capable of communicating on a first RAT while connected to a second RAT. In one configuration, the first RAT is 3G/2G and the second RAT is LTE or vice versa. For example, a circuit-switched fall back capable UE may initiate a mobile-originated (MO) circuit-switched voice-call while on LTE, resulting in the UE being moved to a circuit-switched capable radio access network (RAN), such as 3G or 2G for a circuit-switched voice-call setup. A circuit-switched fall back capable UE may also be paged for a mobile-terminated (MT) voice call while on a specific RAT, resulting in the UE being moved to another RAT for a circuit-switched voice call setup.

Efforts have been made to reduce the call setup latency for CSFB, such as reducing the time spent in the system information block (SIB) collecting procedure via skipping non-important system information blocks or system information block tunneling.

For improved use of a physical channel, such as a dedicated physical channel (DPCH), a time division duplexing (TDD) or a TD-SCDMA system may specify time division multiplexing on the physical channel. The physical channel may also be referred to as an associative physical channel, such as an associative-DPCH (a-DPCH).

Aspects of the present disclosure are directed to reducing the time spent in the random access process that is used for the circuit-switched fall back from a first RAT to a second RAT.

In a typical system, the UE randomly selects one uplink pilot channel (UpPCH) sub-channel and one synchronous uplink (SYNC-UL) sequence from those available for the given access service class (ASC). The UE transmits the synchronous uplink sequence on the uplink pilot channel sub-channel. The synchronous uplink sequence may be transmitted at the UE's signature transmission power. After transmitting a synchronous uplink sequence, the UE listens to the relevant fast physical access channel (FPACH) for the next wait time (WT) subframes to receive the network acknowledgement.

When a collision occurs, or if the UE is in a bad propagation environment, the eNodeB or base station may not receive the synchronous uplink sequence. Also, the UE may not receive any response from the eNodeB. Therefore, the UE may have to adjust its transmission time and transmission power level based on a new measurement and transmit another synchronous uplink sequence after a random delay period.

In some RATs, such as Wideband Code Division Multiple Access (W-CDMA), or LTE, the UE typically waits for a shorter time interval in order to transmit a second preamble, in case the first preamble fails. Additionally, for other RATs, such as TD-SCDMA, the UE has a wait time of typically four periods plus one, plus a random delay period, to subsequently transmit a second synchronous uplink sequence in case of failure of the first synchronous uplink sequence.

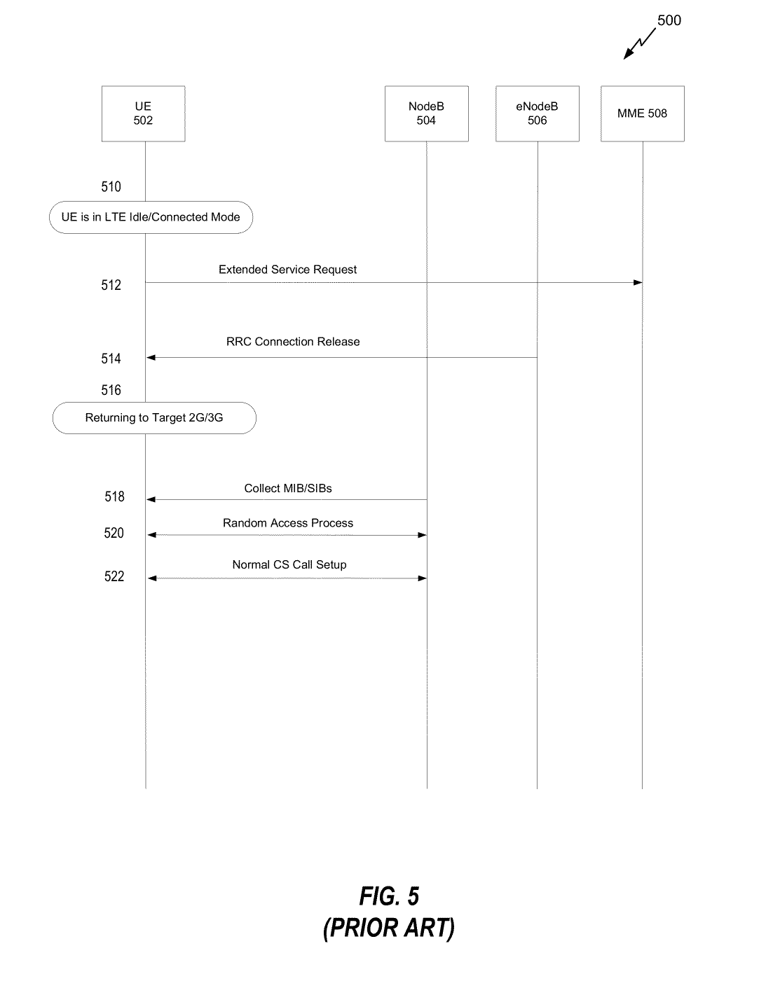

FIG. 5 illustrates a call flow 500 of a typical network. A UE 502 is engaged in communications with a TD-SCDMA NodeB 504, an LTE eNodeB (or base station) 506 and a mobility management entity (MME) 508, which may be a key control node for the network. At time 510, the UE 502 is in the idle or connected mode. At time 512, the UE 502 transmits an extended service request to the MME 508, which may be an indicator for a mobile-originated (MO) or mobile-terminated (MT) circuit-switched fall back (CSFB) call. That is, the extended service request transmitted at time 512 indicates that a circuit-switched fall back call is being made. At time 514, the eNodeB 506 transmits a radio resource control (RRC) connection release message to the UE 502. The RRC connection release may be without any 2G or 3G redirection information. A fast return flag may also be transmitted with a true value at time 514. The cell quality may also be another piece of information that is transmitted at time 514. At time 516, the UE 502 returns to a target 2G/3G network. At time 518, the TD-SCDMA NodeB 504 transmits a request to the UE 502 to collect the master information block (MIB) and the system information blocks (SIBs). At time 520, the UE 502 and the TD-SCDMA network 504 are in communications with each other to perform a random access process, as described above. At time 522, the UE 502 and the TD-SCDMA network 504 are also in communications with each other to perform a normal circuit-switched (CS) call setup.

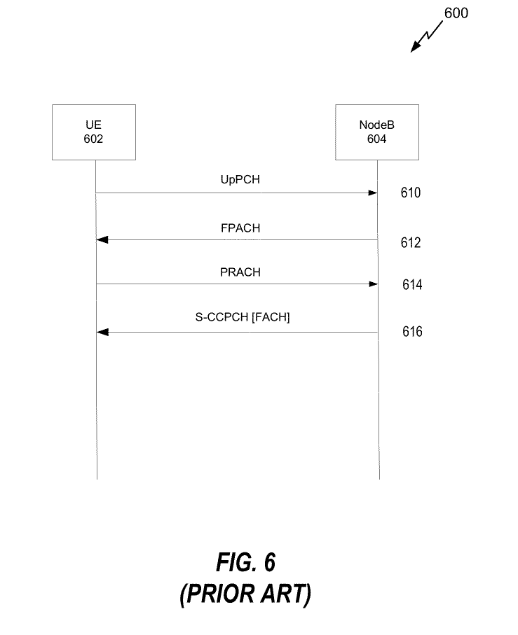

FIG. 6 illustrates a call flow 600 of another typical network. A UE 602 may be in communications with a NodeB (or base station) 604. At time 610, the UE 602 selects and transmits one of N synchronization uplink (SYNC-UL) sequences to the NodeB 604. According to an aspect of the present disclosure, more than one of N synchronous uplink sequences may be transmitted. In one configuration, N may be eight (8). In another configuration, the transmission at time 610 may also take place over an uplink pilot channel. At time 612, the NodeB 604 transmits an acknowledgment signature as well as power and timing adjustment commands to the UE 602. In one configuration, the transmission at time 612 may take place on a fast physical access channel (FPACH).

At time 614, the UE 602 uses codes associated with the fast physical access channel in addition to the power and timing adjustment commands to transmit a signal to the NodeB 604. In one configuration, the transmission at time 614 may take place over a physical random access channel (PRACH). At time 616, the NodeB 604, assigns channels in terms of information that includes carriers, codes, time slots and midambles. The NodeB 604 then transmits this information including carriers, codes, time slots and midambles to the UE 602. In another configuration, a secondary common control physical channel (S-CCPCH) or a forward access channel (FACH) may be used for the transmission at time 616. In yet another configuration, the secondary common control physical channel may function as a forward access channel.

In contrast to some RATs such as LTE or W-CDMA, TD-SCDMA RATs may use eight synchronous uplink sequences for random access. A synchronous uplink sequence, such as SYNC-UL, may be used for uplink synchronization and random access. Typically, a TD-SCDMA system has 256 usable synchronous uplink sequences.

To reduce collision of two or more UEs selecting the same synchronous uplink sequence, an uplink pilot channel with sub-channels may be specified. The uplink pilot channel may have N sub-channels, which may be numbered from 0 to N−1. Sub-channel for the uplink pilot channel may be defined as a time slot, such as the UpPTS (Up Pilot Time Slot), in the subframe where (subframe number) mod N=i. Mod refers to the modulo or modulus operation. At the beginning of the frame, the subframe number is set to zero. Some UEs may be limited to performing a random access channel (RACH) procedure on one subset of a total of N subframes. Still, other UEs may be limited to performing a RACH procedure on other subsets of a total of N subframes.

For example, if a UE is limited to performing a RACH procedure on sub-channel seven, then the UE may wait seven subframes to perform the RACH procedure. This reduces the probability of collisions yet also increases the latency, which leads to slower performance. Reducing the latency improves the efficiency of circuit switched fall back calls.

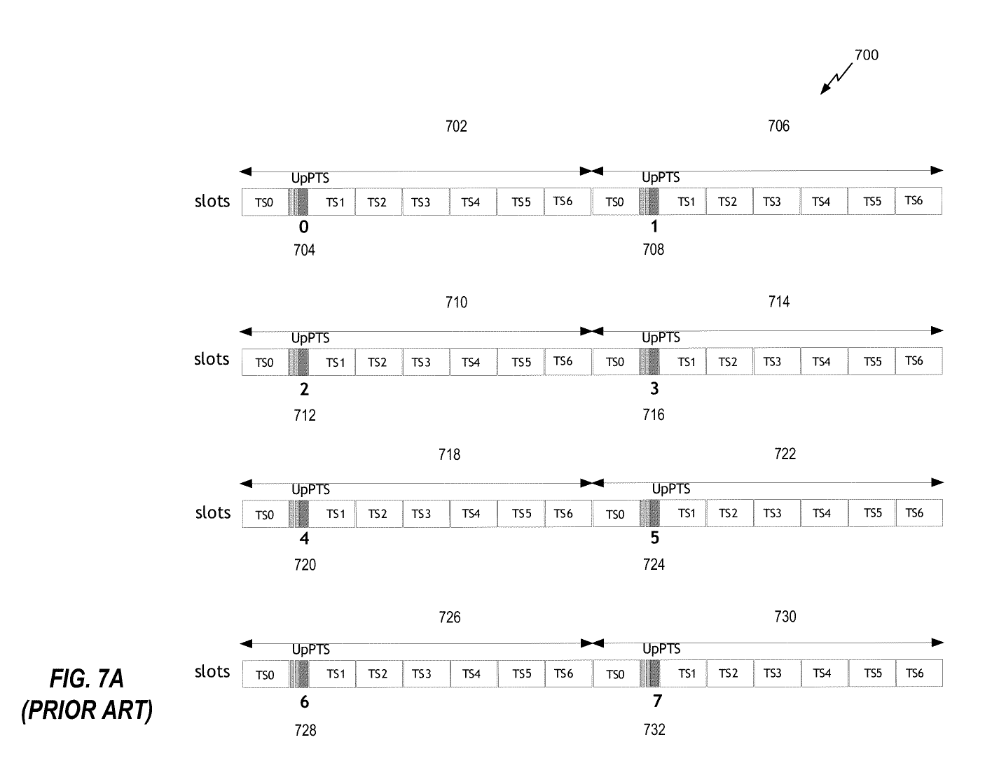

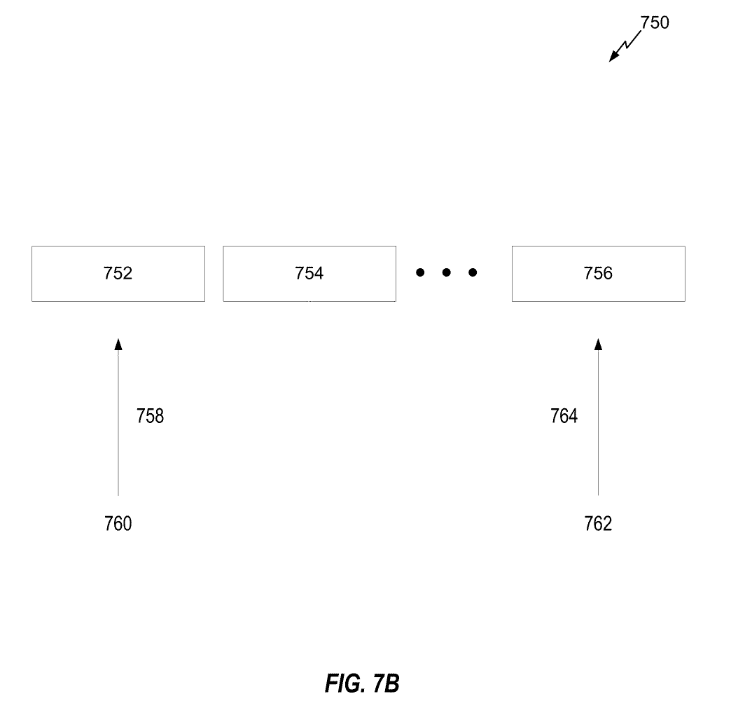

FIG. 7A illustrates a timing diagram 700 of typical subframes for use by an uplink pilot channel. As shown in FIG. 7A, each of a set of subframes 702, 706, 710, 714, 718, 722, 726 and 730 has a corresponding uplink pilot channel sub-channel 704, 708, 712, 716, 720, 724, 728 and 732, respectively. The uplink pilot channel may have N sub-channels that are numbered from 0 to N−1. In the timing diagram 700 of FIG. 7, N is eight. The eight sub-channels of the uplink pilot channel are uplink pilot channel sub-channel 0 (704), uplink pilot channel sub-channel 1 (708), uplink pilot channel sub-channel 2 (712), uplink pilot channel sub-channel 3 (716), uplink pilot channel sub-channel 4 (720), uplink pilot channel sub-channel 5 (724), uplink pilot channel sub-channel 6 (728), and uplink pilot channel sub-channel 7 (732). Also, uplink pilot channel sub-channel i is defined as a time slot designated as UpPTS in the subframe (any of the subframes 702-730), where the (subframe number) mod N=i. The subframe number is also set to zero for the first subframe, and counts up to N−1 (in this case, seven). In one configuration, a subframe may be referred to as a sub-channel.

FIG. 7B illustrates a diagram 750 of subframes according to aspects of the present disclosure. To begin a random access process, a UE initially transmits a random access preamble to a network. In one configuration, the random access preamble may be a part of the synchronous uplink sequence transmitted by the UE. The network determines power and timing conditions based on the transmitted preamble. Furthermore, the network transmits the power and timing condition information back to the UE. For certain types of RATs, such as TD-SCDMA, the number of random access preambles may be low, thus increasing the probability of collision if different UEs select the same random access preamble. To reduce the probability of collision, RATs may use multiple subframes, such as subframes (or sub-channels) 752, 754 and 756, as a group, so that each UE in a set of UEs has exclusive access to a particular subframe in a set of subframes. That is, the multiple subframes are configured so that a single UE may transmit a random access preamble on a particular subframe.

For circuit-switched fall back calls, it is desirable to reduce latency. Therefore, a UE initiating the random access procedure for a voice call may transmit a random access preamble on the earliest subframe possible. If the UE waits until later subframes to transmit a random access preamble, like a typical process, then the latency may be increased. According to an aspect of the present disclosure, if the UE determines that a specific call type is being made (such as a circuit-switched fall back call), then a first available subframe may be used to transmit the random access preamble.

For example, when the UE determines that a specific call type is being made, then the UE can transmit a first random access preamble 758 at a first time instant 760 on a first subframe 752, which is the earliest available subframe. If, however, the UE determines a call type is not the specific call type, then the UE can wait until a second time instant 762, in which it transmits a second random access preamble 764 over a second subframe 756. The second subframe 756 is later in time than the first subframe 752. In one configuration, a subframe may be referred to as a sub-channel.

It should be noted that although aspects of the present disclosure are directed to transmitting on the first available subframe, the present disclosure is not limited to transmitting on the first available subframe. That is, aspects of the present disclosure also contemplate transmitting the random access preamble on a subframe that is earlier than a pre-defined subframe. Further, although aspects have described the specific call type as circuit-switched fall back, the present application is not limited to such call types. Other call types, such as emergency calls, are also contemplated.

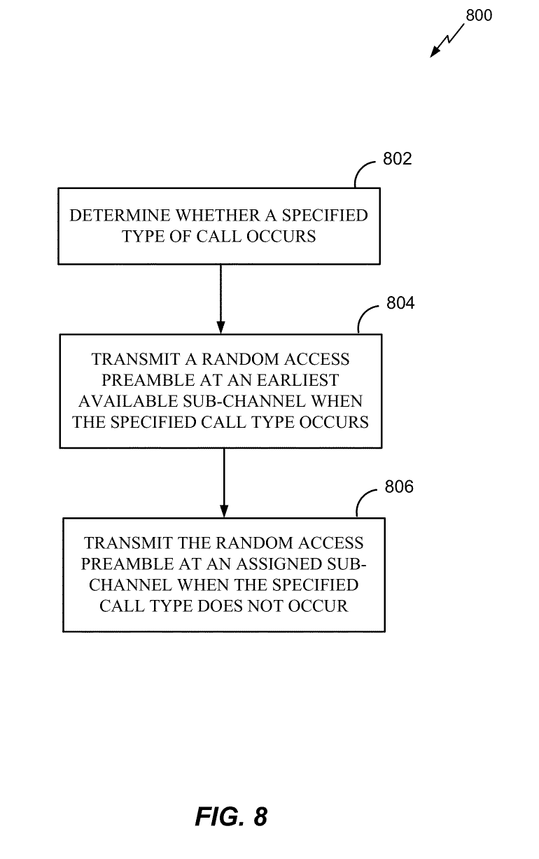

FIG. 8 is a block diagram illustrating a wireless communication method 800 for transmission of preambles according to aspects of the present disclosure. In block 802, the UE determines whether a specific type of call occurs. In one configuration, the specific type of call is a circuit-switched fall back call. In another configuration, the specific type of call is an emergency call. In block 804, the UE transmits a random access preamble at an earliest available sub-channel when the specific call type occurs. In block 806, the UE transmits the random access preamble at an assigned sub-channel when the specific call type does not occur.

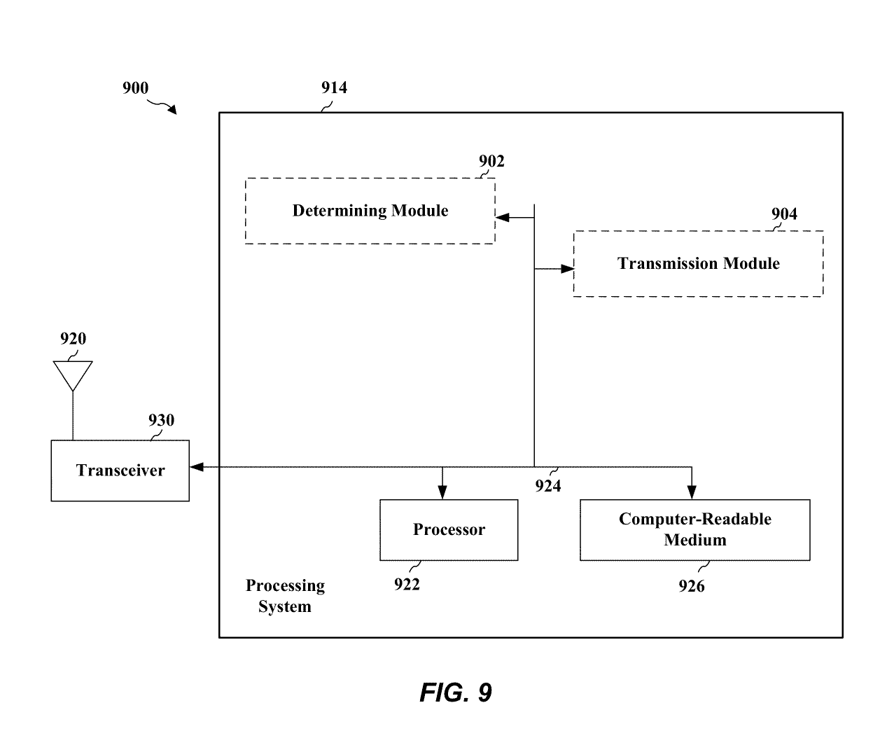

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922, the determining module 902, the transmission module 904, and the computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a determining module 902 for determining whether a specific type of call occurs. The processing system 914 also includes a transmission module 904 for transmitting a random access preamble at an earliest available sub-channel when the specific call type occurs and transmitting the random access preamble at an assigned sub-channel when the specific call type does not occur. The modules may be software modules running in the processor 922, resident/stored in the computer readable medium 926, one or more hardware modules coupled to the processor 922, or some combination thereof. The processing system 914 may be a component of the UE 350 and may include the memory 392, and/or the controller/processor 390.

In one configuration, an apparatus such as an UE 350 is configured for wireless communication including means for determining. In one aspect, the above means may be the controller/processor 390, the memory 392, the preamble transmission module 391, the determining module 902, the processor 922, and/or the processing system 914 configured to perform the functions recited by the aforementioned means. In another aspect, the aforementioned means may be a module or any apparatus configured to perform the functions recited by the aforementioned means.

In one configuration, the apparatus configured for wireless communication also includes means for transmitting. In one aspect, the above means may be the antennae 352, the transmitter 356, the transmit processor 380, the controller/processor 390, the memory 392, the preamble transmission module 391, the transmission module 904, the processor 922 and/or the processing system 914 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a specific call type occurs;
transmitting a random access preamble at an earliest available sub-channel when the specific call type occurs; and
transmitting the random access preamble at an assigned sub-channel when the specific call type does not occur.

2. The method of claim 1, in which the earliest available sub-channel is an uplink pilot channel (UpPCH) in a Time-Division Synchronous Code Division Multiple Access (TD-SCDMA) network.

3. The method of claim 1, in which the random access preamble is a synchronous uplink sequence (SYNC-UL) in a Time-Division Synchronous Code Division Multiple Access (TD-SCDMA) network.

4. The method of claim 1, in which the specific call type is a circuit switched fall back (CSFB) call.

5. The method of claim 1, in which the specific call type is an emergency call.

6. An apparatus for wireless communication, comprising:
means for determining whether a specific call type occurs;
means for transmitting a random access preamble at an earliest available sub-channel when the specific call type occurs; and
means for transmitting the random access preamble at an assigned sub-channel when the specific call type does not occur.

7. The apparatus of claim 6, in which the earliest available sub-channel is an uplink pilot channel (UpPCH) in a Time-Division Synchronous Code Division Multiple Access (TD-SCDMA) network.

8. The apparatus of claim 6, in which the random access preamble is a synchronous uplink sequence (SYNC-UL) in a Time-Division Synchronous Code Division Multiple Access (TD-SCDMA) network.

9. The apparatus of claim 6, in which the specific call type is a circuit switched fall back (CSFB) call.

10. The apparatus of claim 6, in which the specific call type is an emergency call.

11. A computer program product for wireless communication in a wireless network, comprising:
a non-transitory computer-readable medium having non-transitory program code recorded thereon, the program code comprising:
program code to determine whether a specific call type occurs;
program code to transmit a random access preamble at an earliest available sub-channel when the specific call type occurs; and
program code to transmit the random access preamble at an assigned sub-channel when the specific call type does not occur.

12. The computer program product of claim 11, in which the earliest available sub-channel is an uplink pilot channel (UpPCH) in a Time-Division Synchronous Code Division Multiple Access (TD-SCDMA) network.

13. The computer program product of claim 11, in which the random access preamble is a synchronous uplink sequence (SYNC-UL) in a Time-Division Synchronous Code Division Multiple Access (TD-SCDMA) network.

14. The computer program product of claim 11, in which the specific call type is a circuit switched fall back (CSFB) call.

15. The computer program product of claim 11, in which the specific call type is an emergency call.

16. An apparatus for wireless communication, comprising:
a memory; and
at least one processor coupled to the memory, the at least one processor being configured:
to determine whether a specific call type occurs;
to transmit a random access preamble at an earliest available sub-channel when the specific call type occurs; and
to transmit the random access preamble at an assigned sub-channel when the specific call type does not occur.

17. The apparatus of claim 16, in which the earliest available sub-channel is an uplink pilot channel (UpPCH) in a Time-Division Synchronous Code Division Multiple Access (TD-SCDMA) network.

18. The apparatus of claim 16, in which the random access preamble is a synchronous uplink sequence (SYNC-UL) in a Time-Division Synchronous Code Division Multiple Access (TD-SCDMA) network.

19. The apparatus of claim 16, in which the specific call type is a circuit switched fall back (CSFB) call.

20. The apparatus of claim 16, in which the specific call type is an emergency call.
